(19) United States
(12) Patent Application Publication
(10) Pub. No.: US 2014/0073529 A1
(43) Pub. Date: Mar. 13, 2014

(54) SINGLE DONOR VERSUS ELITE PANEL METHODOLOGY FOR IDENTIFICATION OF MARKER-ASSISTED BREEDING FRIENDLY MARKERS

(71) Applicant: Dow AgroSciences LLC, Indianapolis, IN (US)

(72) Inventors: Jafar MAMMADOV, Westfield, IN (US); Siva Prasad KUMPATLA, Carmel, IN (US)

(73) Assignee: Dow AgroSciences LLC, Indianapolis, IN (US)

(21) Appl. No.: 14/024,258

(22) Filed: Sep. 11, 2013

Related U.S. Application Data
(60) Provisional application No. 61/700,427, filed on Sep. 13, 2012.
(60) Provisional application No. 61/702,577, filed on Sep. 18, 2012.

(51) Int. Cl. G06F 19/22

(52) U.S. Cl. CPC G06F 19/22
USPC 506/9

(57) ABSTRACT

Provided herein is a method of identifying at least one marker-assisted breeding friendly marker that is located under the QTL peak, which might or might not represent a causative allele of a phenotype. In an embodiment, a single donor versus elite panel (SDvEP) method is implemented to determine the MAB-friendly marker that is highly associated with trait and might/not discriminate a causative allele for a phenotype. SDvEP method compares the genotype from at least one locus of a donor line with a particular phenotype against a large panel of unrelated lines that all lack the phenotype.

### CROSS-REFERENCE TO RELATED APPLICATIONS

This application claims priority under 35 U.S.C. §119(e) to U.S. Provisional Application Ser. Nos. 61/700,427, filed on Sep. 13, 2012, and 61/702,577, filed on Sep. 18, 2012, the disclosures of both of which are expressly incorporated by reference herein.

### BACKGROUND

Marker-assisted selection (MAS) as a process refers to the selection of superior genotypes using molecular markers. The term was coined in the mid-eighties by Beckmann and Soller (1986) as a technology that might have a potential use in plant breeding. MAS is thought to have substantial advantages over conventional phenotypic selection because the latter could be (1) unreliable when the expression of the trait is environmentally dependent, (2) biologically deadline-sensitive, (3) expensive and difficult to screen and (4) subject to the mercy of weather. In contrast to phenotypic selection, MAS (a) does not rely on environmental conditions because it detects the structural polymorphisms at molecular level, (b) requires leaf tissue collected at seedling stage, which is very useful for traits that are expressed at later stages of development and which also helps to avoid adverse weather conditions that could kill the plant at adult stage, (c) has a potential to be cheaper and less labor intensive, (d) allows selection in off-season nurseries and has a potential to accelerate breeding process.

As of Mar. 9, 2012, there were about 37,700 articles containing the keyword “marker-assisted selection” according to the search engine Google Scholar. Most of the articles still referred to the potential application of MAS in plant breeding. A vast majority of those publications were from academia. Although private industry does not normally release the details of their breeding methodologies to the public domain, several industry articles on successful application of MAS in the development of varieties of maize (Ragot et al., 2007) and soybean (Cahill and Schmidt, 2004; Crosbie et al., 2003) have published.

Fairly low impact of academic research in developing varieties using MAS can be explained by the lack of funding to complete the entire marker development pipeline (MDP), which can be a long-term and cost-intensive task. MDP includes several steps such as (1) population development, (2) initial quantitative trait locus (QTL) mapping, (3) QTL validation (testing in several locations and years and implementing fine mapping) and (4) marker validation (development of inexpensive but high-throughput assays that are amenable to automation) (Collard and Mackill, 2008). Every step of the development of markers linked to QTL is associated with numerous constraints which may take several years and substantial funding to resolve. In the 1990s it was believed that molecular markers identified at step 2 were enough for successful MAS. Later it was observed that markers that were previously declared as tightly linked were failing to confirm the phenotype at advanced stages of MAS. One of the main reasons for the failure of a marker in MAS, which was identified at pre-fine mapping step, was the inconsistency in QTL mapping. Detection of QTL within one year and in one location was proved to be not enough to claim the robust QTL location because the expression of latter had been environmentally dependent. Thus, QTL validation and confirmation was required, which foresaw QTL mapping based on data collected within several years and multiple locations. Molecular markers that were tightly linked to QTL and were consistent across several years and locations did have a potential in MAS. However, even after QTL validation, so called “tightly linked marker” hardly met the expectations because the confidence interval (CI) of QTL peak was so large that it was very difficult to predict the real distance between a marker and QTL.

### SUMMARY OF THE INVENTION

Provided herein is a method of identifying a molecular marker/s located under the QTL peak and thus is highly associated with a trait of interest, which might or might not represent at least one causative allele of a phenotype. This molecular marker discriminates an allele that is unique to a donor line and absent in many un-related inbred lines with one common feature which is a lack of the trait of interest. Implementation of this marker in marker-assisted selection eliminates a risk of selecting false positive lines, which is why this type of marker is named here as marker-assisted breeding (MAB) friendly marker. In an embodiment, a donor unique allele can be a single nucleotide polymorphism. After localizing a QTL to a particular region, bulk segregant analysis (BSA) is carried out to identify a group of markers that are highly associated with a trait. Finally, the last step is the implementation of single donor versus elite panel (SDvEP) method to determine the MAB-friendly marker, which might or might not represent a causative allele for a phenotype. SDvEP method compares genotypic data of markers derived from fingerprinting DNA of a donor line with a phenotype of interest and a panel of unrelated lines that lack that phenotype.

In an embodiment, SDvEP has an ability to discover a MAB-friendly marker among a large number of markers highly-correlated with a trait and thus increases the resolution of a QTL interval controlling a phenotype. The phenotype can be disease resistance and any other trait. The method is applicable to any crop. Within the confidence interval, markers assess alleles for their conservation within a particular genome exhibiting the phenotype and their absence from a panel of unrelated lines lacking the phenotype. In an embodiment, bulk segregant analysis is performed to find a group of markers within the QTL confidence interval that are highly correlated with the phenotype prior to SDvEP analysis. In an embodiment, SDvEP analysis determines a MAB-friendly marker that might or might not represent a causative allele for disease resistance.

### BRIEF DESCRIPTION OF THE DRAWINGS

FIG. 1 shows the analysis of a QTL in three locations in 2011. QTL confidence intervals (Mbp) in Sidney, Ill.; Davenport, Iowa; and Mt. Vernon, Ind. (shortest to longest). (★) QTL peak regions in three locations, (▴) marker identified by SDvEP method; (star) peak of QTL confidence interval; (□) recombination blocks; () region detected by Bulk Segregant Analysis.

FIG. 2 shows that SDvEP was able to identify a single marker out of 182 where the resistant allele was completely absent in 71 susceptible lines. The single dot (marked with the solid arrow) represents the “T” allele only available in the genome of a resistant line. The multiple dots (marked with the dashed arrow) represent the “C” allele in the genomes of all susceptible elite lines.

### DETAILED DESCRIPTION

### Definitions

The term “allele” refers to any of one or more alternative forms of a gene locus, all of which alleles relate to one trait or characteristic. In a diploid cell or organism, the two alleles of a given gene occupy corresponding loci on a pair of homologous chromosomes.

The term “backcrossing” refers to a process in which a breeder repeatedly crosses hybrid progeny, for example a first generation hybrid (F₁), back to one of the parents of the hybrid progeny. Backcrossing can be used to introduce one or more single locus conversions from one genetic background into another.

The term “causative allele” refers to an allele that is responsible for a particular phenotype.

The term “crossing” refers to the mating of two parent plants.

The term “desired agronomic characteristics” refers to agronomic characteristics (which will vary from crop to crop and plant to plant) such as yield, maturity, pest resistance and lint percent which are desired in a commercially acceptable crop or plant. For example, improved agronomic characteristics for cotton include yield, maturity, fiber content, and fiber qualities.

The term “diploid” refers to a cell or organism having two sets of chromosomes.

The term “disease resistance” refers to the ability of plants to restrict the activities of a specified pest, such as a fungus, virus, or bacteria.

The term “donor parent” refers to the parent of a variety which contains the gene or trait of interest which is desired to be introduced into a second variety.

The term “double haploid” refers to a plant that has cells with two exactly identical sets of genes. The production of double haploids can also be used for the development of homozygous varieties, or inbred lines, in a breeding program. Double haploids are produced by the doubling of a set of chromosomes from a heterozygous plant to produce a completely homozygous individual plant.

The term “genotype” refers to the genetic constitution of a cell or organism. “Genotyping” is the determination of the sequence of a cell, allele, loci, etc.

The term “linkage” refers to a phenomenon wherein alleles on the same chromosome tend to segregate together more often than expected by chance if their transmission was independent.

The term “locus” refers to a short nucleotide sequence that is usually found at one particular location in the genome by a point of reference; e.g., a short DNA sequence that is a gene, or part of a gene or intergenic region.

The term “pathologist” refers to a person evaluating the severity of a plant disease. For uses herein, a pathologist does not requiring credentialing.

The term “phenotype” refers to the detectable characteristics of a cell or organism, which characteristics are the manifestation of gene expression. The term “phenotype” and “trait” are used interchangeably herein.

The term “polymorphism” refers to a structural (i.e. nucleotide) allelic variation within a particular locus. A polymorphism can include a single nucleotide polymorphism (SNP), where there is a change at a single nucleotide. A polymorphism also includes one or more base changes, one or more insertions, or one or more deletions of one or more nucleotides in a genome.

The term “quantitative trait loci” or “QTL” refers to genetic loci that control to some degree numerically representable traits that are usually continuously distributed.

The term “QTL confidence interval” or “QTL CI” refers to the region of a genome, which is significantly (based on statistics) associated with a trait.

The term “recurrent parent” refers to the repeating parent (variety) in a backcross breeding program. The recurrent parent is the variety into which a gene or trait is desired to be introduced.

### Molecular Mapping of Traits

QTL mapping using molecular markers is a well known method to identify the chromosomal positions of loci that putatively control agronomically important traits. Marker-assisted selection in the breeding process is based upon the tracking of alleles favoring or negatively effecting a trait of interest using molecular markers linked to the loci of interest. Genetic proximity of a marker to a trait is a major factor affecting marker-assisted selection. Genetic proximity of a marker to QTL depends on two factors such as the size of the mapping population and the patterns of recombination frequency of the region of a genome where the marker and QTL are residing. If the size of the mapping population is small (100-200 individuals), then an assertion of having a marker closely-linked to a gene is barely valid since fine mapping will identify many crossing-over events happening within marker-gene complexes. Occurrence of recombination events between a marker and QTL breaks the linkage between two chromosomal landmarks and makes a marker unable to track a target. This type of situation is especially true for regions of a genome with high rate of recombination frequency.

The availability of dense genetic maps with informative markers makes it possible to map genes and QTL. Numerous studies have been dedicated to mapping QTL governing major agronomically important traits. As of Apr. 4, 2012, there were about 65,000 research articles in this direction in Google Scholar. However, majority of those studies ended at the initial mapping step and did not pursue the ultimate goal of cloning the gene(s) underlying the QTL due to many reasons including lack of funding, insufficient genomic resources, inadequate phenotypic data collection method, experimental designs with limited detection power and finally complexity of the trait and the genome. Due to these factors, QTL cloning in crops remains a very challenging process. Researchers have to undergo multiple labor-, time- and cost-intensive steps prior to answering the question “to clone or not to clone plant QTL” (Salvi and Tuberosa, 2005, 2007).

A QTL region can comprise multiple genes which are located within a contiguous genomic region or linkage group, such as a haplotype. As used herein, a QTL can encompass more than one gene or other genetic factor where each individual gene or genetic component is also capable of exhibiting allelic variation and where each gene or genetic factor is also capable of eliciting a phenotypic effect on the quantitative trait in question.

An embodiment includes a method for selection and introgression of a QTL for a phenotype (e.g., disease resistance) comprising: (a) isolating nucleic acids from a plurality of plants; and (b) detecting in said isolated nucleic acids the presence of one or more marker molecules associated with a QTL phenotype (e.g., disease resistance). In an embodiment this screening is done in plants with the phenotype and without the phenotype.

From scientific point of view to elucidate the molecular mechanism of a trait is crucial. However, taking into account the amount of time and resources that a scientist has to spend identifying a causative mutation, these efforts could be very impractical. Especially it is true for the commercial organizations where the pace of discovery efforts has to match the rate of competition. From this prospective, the identification of a robust and informative molecular marker that is closely linked to QTL of interest and could be used in marker-assisted selection and breeding is a priority.

It is quite common to state that a marker is tightly linked to QTL when the marker is statistically associated with phenotypic data. Those markers are normally located under the highest peak of the QTL. However, this association depends on how robust and accurate the phenotypic data are. Manifestation of a disease can vary depending on quality of inoculums and weather conditions favoring/impeding the disease onset. The quality of phenotypic data can also depend on the skills of a scientist who scores the disease severity.

Bulk Segregant analysis (BSA) is an inexpensive method to find a group of markers within the QTL CI that is associated with a phenotype. However, BSA lacks the ability to determine which marker out of this group discriminates the allele (not necessarily a causative one) that is evolutionary preserved in the donor line only and absent in varieties that do not have this trait. Fine mapping is a perfect way to reduce the QTL CI and identify a causative allele. However, it is a very time- and resource-intensive method. In embodiments, a mapping population is a population of segregating plant genomes sharing the same parentage. A plant can be, but is not limited to, maize, soybean, sorghum, rice, etc.

Single Donor Vs. Elite Panel

Single Donor vs. Elite Panel (SDvEP) has the potential to find a molecular marker under the QTL CI that discriminates an allele which is present in a genome of a single donor variety that has a trait, and absent in genomes of varieties that do not have this trait. The main concept of this method is an assumption that a causative mutation controlling a trait is evolutionary conserved in a donor line and absent in unrelated elite lines which explains the lack of a trait in those line. (Table 1). A marker identified by SDvEP method might or might not represent the causative mutation though. However, a marker will (1) be significantly associated with a trait (2) at least detect an allele that is a characteristic of a donor line only and (3) can be easily tracked in segregating populations without a fear of selecting false positive plants. Marker detected by this method is called marker-assisted breeding (MAB) friendly marker. This method is ideal for the traits which are controlled by a single gene or by major QTL and several minor QTL. This method has no value if the trait is controlled epigenetically, which assumes no structural variations.

TABLE 1
A single donor vs. elite panel (SDvEP) used to identify MAS-friendly
molecular markers from a large QTL region. SD, single donor; E1
to E6, elite lines that do not have an allele of interest.

| | A/C | G/C | G/A | T/C | A/T | A/G | G/T | T/C | G/C |
|---|---|---|---|---|---|---|---|---|---|
| SD | A | G | A | T | A | G | T | C | G |
| E1 | C | C | G | C | T | A | G | T | C |
| E2 | C | C | G | T | T | A | T | T | C |
| E3 | C | C | A | C | T | G | T | C | G |
| E4 | A | C | A | T | T | G | G | C | G |
| E5 | A | G | A | C | T | A | T | C | C |
| E6 | C | G | A | T | T | A | T | C | G |

### Method

Instead of applying high-resolution mapping to find a marker tightly linked to a QTL controlling a trait, SDvEP method can be leveraged. The key role in successful application of this method belongs to the process of the development of a panel of diverse unrelated lines that do not have that particular trait. If the trait is quantitatively inherited and its expression could be affected by environment, the panel has to be tested in several environments to ensure the robustness of a phenotype. The larger the panel, the higher the probability of finding an allele that is truly conserved in a donor line. An important prerequisite for the SDvEP method is knowledge of the mapping position of QTL controlling a trait. This information is necessary to identify molecular markers under the QTL confidence interval to implement the second step of SDvEP, namely genotyping the single donor line and a panel of elite lines with those markers. In order to be cost-effective and genotype the minimal number of markers, it is recommended to implement bulk segregant analysis using the Lasso model. BSA will help to identify a smaller group of markers that are highly associated with a trait. In an embodiment, QTL mapping is followed by BSA to narrow the number of possible loci under the QTL peak. In an embodiment, SDvEP resolves the phenotype to specific loci, a single locus, or even a single nucleotide. SDvEP is an inexpensive and resource-effective method to identify MAB friendly markers within a QTL confidence interval. If the group of markers for genotyping is small it is recommended to use Kbiosciencs Competitive Allele Specific PCR (KASPar) assay, otherwise Illumina's GoldenGate and Infinium assays could be leveraged to implement genotyping. Alternatively, single donor line and a panel of elite lines could be genotyped by sequencing and then polymorphism fitting the SDvEP concept could be computationally identified under the QTL CI.

### EXAMPLE

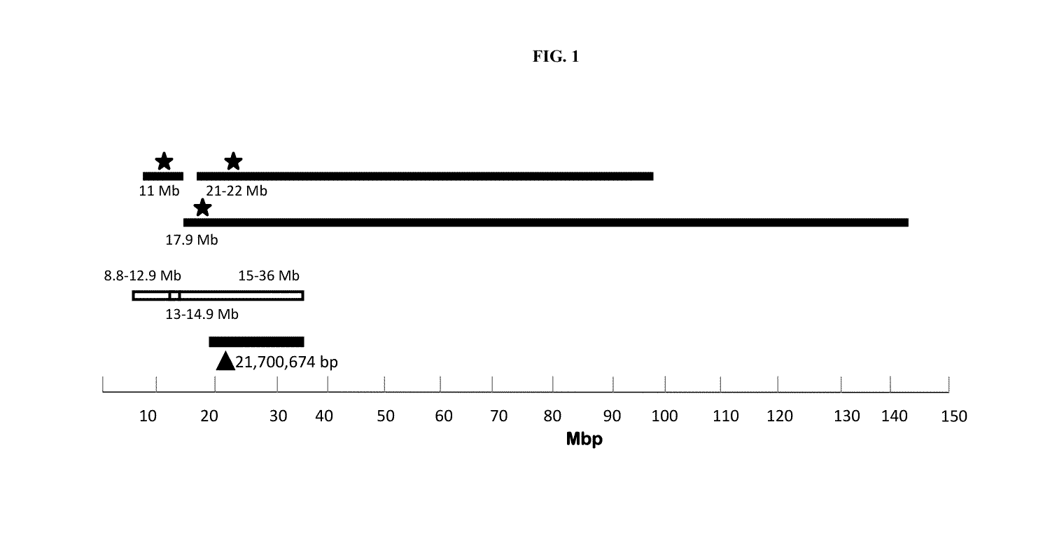

QTL mapping efforts resulted in the identification of a major QTL, which explained 28-33% of variation depending on location and was consistent in all three environments. The confidence interval of the major QTL spanned the region from 8-99 Mb covering almost the entire chromosome (FIG. 1). This happened due to the small size of the mapping population. Approximately 200 SNP markers were located under the QTL peak. Theoretically, any of the 200 markers could be considered genetically linked to the trait; however practically, not all of them are useful for marker-assisted selection because they might discriminate alleles that are present both in resistant line and other susceptible lines. To identify which marker is MAB-friendly and potentially could represent a causative mutation by using traditional methods, the mapping population would have had to be increased by 10-20 fold to identify new recombinants, plant a population, and collect further phenotypic data. Instead, 71 known susceptible un-related inbred lines and a single resistant line from this study were genotyped by SNP markers located under the QTL peak and assessed by SDvEP method to identify a MAB-friendly marker that would discriminate the allele which is present in the resistant line and absent in the genomes of the entire panel of 71 susceptible elite lines.

### Materials and Methods

Genetic Materials.

Seventy two doubled haploid (DH) lines of an inbred corn line that is resistant for the desired trait x an inbred corn line that is susceptible for the desired trait along with parents and a panel of 71 unrelated susceptible lines were planted in three locations such as Mount Vernon (Ind.) (here after referred as MV), Davenport (Iowa) (here after referred as DAV) and Sidney (Ill.) (here after referred as SID) in spring 2011. Fifteen kernels per line were planted in a single row.

Phenotypic Data Collection.

In each environment phenotype ratings were conducted at least two times with the first rating immediately after flowering. In MV, phenotypic data were collected twice, 39 and 53 days after inoculation. In DAV, the phenotype was also rated twice, 38 and 67 days after inoculation. In SID, phenotype ratings were conducted four times, 48, 62, 76 and 90 days after inoculations. Differences in rating dates were purely conditioned by the availability of scientists to evaluate the inbreds.

Genotyping.

The mapping population was genotyped with two custom iSelects® (Illumina, Inc., San Diego, Calif.)—45K and 12K attempted bead types. The 45K iSelect® included 34322 gene-based single nucleotide polymorphisms (SNPs) evenly distributed across all ten maize chromosomes. The 12K iSelect® was composed of 9435 SNPs.

QTL Analysis.

Windows QTL Cartographer 2.5 (Wang et al., 2011) was used for quantitative trait loci (QTL) mapping. This software has a calculation limitation of 1000 loci. SNP markers were selected based on their physical coordinates corresponding to reference genome B73 version 2 for even coverage (iSelect® data: 63 samples with 968 SNP markers). The genotype data were translated with the following scheme: genotype AA (susceptible) as 2 and BB (resistant) as 0. Composite interval mapping with default parameters using backward regression elimination method was performed after single marker analysis and simple interval mapping. The significance threshold was calculated with 500 permutation tests.

Recombination Blocks.

Recombination blocks were identified by the calculation of all two way correlations between each marker (R2). Physical positions of all markers (based on maize reference genome version2) were used to order the markers within blocks. All markers with R2≧0.9 correlation were considered to be part of a linkage/recombination block.

Bulk Segregant Analysis.

In order to perform bulk segregant analysis (BSA), i.e. to find a group of markers that were highly correlated with phenotype, the Lasso Penalized Logistic Regression method was applied. The method was described in Wu et al. (2009). Bulks were composed of 9/10 lines where each that were susceptible/resistant in all three environments (Davenport, Iowa; Mt. Vernon, Ind.; and Sidney, Ill.).

### Results

QTL analysis was based on data collected in all three locations using an immortal double haploid population.

QTL Analysis.

In all three locations, the resistant QTL was mapped to the same chromosome. The identified major QTL explained 28-33% of phenotypic variation depending on location and was consistent in all three environments. The confidence interval of the major QTL spanned the region from 8-99 Mb covering almost entire chromosome (FIG. 1). This was due to the small size of the population. The locations of QTL peaks varied depending on environments but were consistently associated with the region located within 11-22 Mb segment of the chromosome (FIG. 1). This 11 Mb region harbored several hundred markers. In this small mapping population, all markers located within the 11 Mb region could be claimed as tightly linked because genetically this distance was equal to 2.1 cM. In order to understand the recombination landscape within the target region, linkage blocks were calculated.

The 11 Mb region was revealed to be located within three recombination blocks (FIG. 1) with a total number of 246 SNPs. Block 1 spanned the 8.8.-12.9 Mb region and contained 34 markers. Block 2 encompassed the 12.9-14.9 Mb region of the chromosome and harbored 20 markers. Finally, block 3 covered the 17-36 Mb segment and had 192 polymorphic markers. Thus, 1.9 Mb of 11 Mb of QTL peak region was located in block 1, the entire block 2 was located within QTL peak region, and 6.9 Mb of 11 Mb QTL peak region was located with block 3.

Bulk Segregant Analysis.

In order to confirm which block was highly associated with the phenotype, BSA was implemented. Based on the data, BSA revealed that markers within blocks 1 and 2 were less correlated with phenotype (R²=0.72) than markers within block 3. However, not all markers were equally highly correlated with bulks, even within block 3. BSA revealed two subgroups of markers. The first subgroup of markers was located within 17-20.2 Mb and was correlated with phenotype at R²=0.91. The second subgroup of markers spanned from 20.6 Mb-36 Mb and showed a perfect correlation with bulks (R²=1). Based on BSA, it was concluded that the target region which putatively harbors QTL controlling resistance could locate somewhere within 20.6-36 Mb region. As QTL peaks spanned from 11-22 Mb region, the target region could be reduced even more to 20.6-22 Mb region only.

SDvEP Analysis.

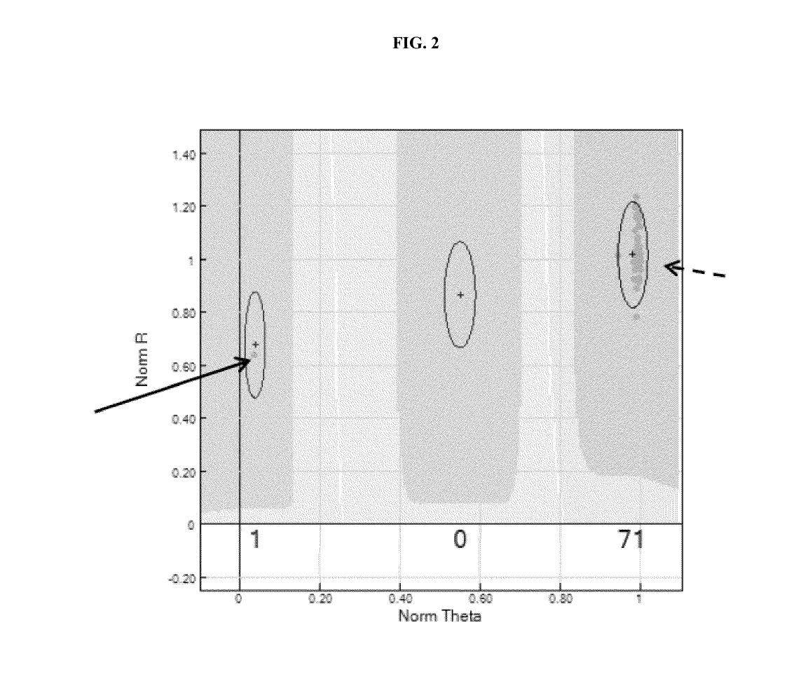

One hundred eighty-two markers within the target region were further subject to SDvEP analysis. The objective was to identify the landmark among 182 markers that would discriminate an allele conserved in the resistant line only. Alleles of all 182 SNPs were compared among a resistance donor and 71 elite inbred lines that were highly susceptible to the disease in all three locations. SDvEP analysis identified one marker out of 182, whose resistant allele was completely absent in all 71 susceptible lines (FIG. 2).

Validation of SDvEP-Derived Marker Using Diverse Inbred Lines and DAS Hybrids. Several maize lines from Dow AgroSciences and the International Maize and Wheat Improvement Center (“CIMMYT”) with known reaction to the disease were genotyped using the single marker identified by SDvEP analysis to reveal the frequency of the resistant allele. Table 2 shows that among seven DAS resistant lines, four inbreds carry the resistant allele [T], including two DAS inbreds, which exhibit excellent resistance to the disease. Inbred 3 is the best resistant line, which has an ability to withstand harsh disease pressure in Brazil. Although Inbred 2 also possesses the resistant allele, its resistance to the disease has not been as strong as its sister line Inbred 1 (data not shown), which indicates that the latter possesses some other minor QTL that cumulatively makes this inbred line more resistant than Inbred 2. Three other lines, Brazil 1, Brazil 2, and Brazil 3 carry the susceptible allele ([C]) while remaining resistant. This finding indicates that these three Brazilian lines might have different loci responsible for resistance, and represent different sources of resistance to the disease.

TABLE 2

| Lines | Origin | SNP |
|---|---|---|
| Inbred 1 | DAS (Argentina) | T |
| Inbred 2 | DAS (Argentina) | T |
| Inbred 3 | DAS (Brazil) | T |
| Inbred 4 | DAS (Brazil) | T |
| CML 519 | CIMMYT, sub-tropical | T |
| CML376 | CIMMYT, sub-tropical | T |
| CML282 | CIMMIT, lowland | T |
| Brazil 1 | DAS (Brazil) | C |
| Brazil 2 | DAS (Brazil) | C |
| Brazil 3 | DAS (Brazil) | C |
| CML275 | CIMMYT, Africa | C |
| CML489 | CIMMYT, Africa | C |
| CML381 | CIMMYT, Subtropical | C |

The marker identified by SDvEP was tested in a hybrid background too (Table 3). A high impact DAS elite line that is susceptible was crossed with Inbred 1 in 2009 in order to introgress resistance. Within several years, breeders had been advancing the best derivatives of that cross taking into account their overall field performance as well as resistance/tolerance. Eight F4 selections were crosses to two testers I and II. The former is moderately resistant and the latter is susceptible to the disease. Genotyping of the eight F4 selections with the marker identified by SDvEP showed that three out of eight selections had susceptible allele [C], while three other selections had resistant allele [T]. When all selections were crossed with moderately resistant tester I, six out of eight hybrids showed moderate to high tolerance to the disease, including two selections that had susceptible allele of the marker identified by SDvEP. However, crosses with the susceptible tester II revealed only three resistant hybrids, which derived from selections that carried the resistant allele of the marker identified by SDvEP. This small validation test clearly showed that the marker identified by SDvEP has an excellent discriminatory ability in a hybrid background too. Thus, SDvEP method was able to identify MAB-friendly marker under the QTL CI without necessity to conduct fine mapping.

TABLE 3

| F4 | Tester | Tester | SNP Marker |
|---|---|---|---|
| Selections | I | II | ID'd By SDvEP |
| AA | 8 | 5 | C |
| BB | 5 | 5 | C |
| CC | 6 | 6 | C |
| DD | 8 | 7 | C |
| EE | 7 | 6 | C |
| FF | 8 | 8 | T |
| GG | 9 | 8 | T |
| HH | 8 | 8 | T |

In summary, implementation of SDvEP method is viable only after actual QTL mapping followed by BSA because classical QTL mapping identifies regions of the chromosomes statistically associated with a trait, then BSA narrows down that location and finally SDvEP increases the resolution to a single base (FIG. 1). Thus, classical QTL mapping coupled with BSA is a prerequisite for SDvEP implementation. To conclude, SDvEP is inexpensive and resource-effective method to identify MAB friendly marker within QTL CI. In this study SDvEP method was able to resolve the QTL region by about 182 times (182/1).

1. A method of identifying a mutation that is associated with a trait comprising
a) comparing all alleles within a quantitative trait loci (QTL) confidence interval between a single donor line and two or more unrelated lines that lack said trait, and
b) identifying at least one allele that is completely absent from lines that lack said trait.

2. The method of claim 1, further comprising determining a nucleotide sequence that is different in the donor line than the unrelated lines.

3. The method of claim 2, wherein in the nucleotide sequence is a single nucleotide polymorphism.

4. The method of claim 1, wherein the QTL confidence interval comprises at least 40 different markers.

5. The method of claim 1, wherein the QTL confidence interval comprises at least 50 different markers.

6. The method of claim 1, wherein the QTL confidence interval comprises at least 100 different markers.

7. The method of claim 1 further comprising genotyping at least one QTL confidence interval.

8. The method of claim 1 wherein the trait is disease resistance.

9. A method of determining an allele associated with a phenotype comprising:
a) mapping quantitative trait loci (QTL) in a plant genome;
b) implementing bulk segregant analysis (BSA) within a QTL confidence interval; and
c) identifying one or more markers determined by the BSA that discriminates for the phenotype.

10. A method of identifying a mutation that is associated with a trait comprising
a) detecting at least one molecular marker in a single donor with the trait and a panel of unrelated lines not having the trait, and
b) identifying at least one allele that is completely absent from lines that lack said trait.

11. The method of claim 10, wherein the trait is disease resistance.
